(19) United States
(12) Patent Application Publication
(10) Pub. No.: US 2025/0324492 A1
(43) Pub. Date: Oct. 16, 2025

(54) INDUCTION COIL FOR AN ELECTRIC COOKING APPLIANCE AND ELECTRIC COOKING APPLIANCE

(71) Applicant: E.G.O. Elektro-Gerätebau GmbH, Oberderdingen (DE)

(72) Inventor: Christian Egenter, Bretten (DE)

(21) Appl. No.: 19/174,433

(22) Filed: Apr. 9, 2025

(30) Foreign Application Priority Data
Apr. 11, 2024 (DE) 10 2024 110 079.6

(51) Int. Cl. H05B 6/12

(52) U.S. Cl. CPC H05B 6/1254; H05B 6/1281

(57) ABSTRACT

An induction coil for a cooktop has a winding body in the form of a flat, spirally wound coil and at least four identical individual ferrite bodies therebelow. The ferrite bodies each have two regions, wherein a first, inner region is a stem region extending radially, and a second, outer region is a head region which adjoins the stem region and is wider in terms of angular degrees at its greatest width than the stem region at its greatest width. In terms of absolute width, it is over 50% wider than the stem region at its greatest width and projects radially beyond the winding body. The stem region widens radially in terms of absolute width from radially inside to radially outside, wherein it narrows radially in terms of angular degrees from radially inside to radially outside over a range of between 40% and 80% of the radius of the winding body or over a range of between 25% and 75% of the length of the ferrite body.

### CROSS-REFERENCE TO RELATED APPLICATIONS

This application claims priority to DE Application No. DE 102024110079.6, filed Apr. 11, 2024, entitled “Induction Coil for an Electric Cooking Appliance and Electric Cooking Appliance,” the entirety of which is hereby incorporated by reference.

### FIELD OF APPLICATION AND PRIOR ART

The invention relates to an induction coil for an electric cooking appliance, wherein the induction coil has a plurality of ferrite bodies. Furthermore, the invention relates to use of specific ferrite bodies in such an induction coil, in order to transfer inductive power from the induction coil to an electrical consumer with an opposing induction coil or receiver coil positioned at a given distance from the induction coil. Finally, the invention also relates to an electric cooktop with a cooktop plate and a plurality of induction coils according to the invention.

DE 10 2016 208 233 A1 discloses an induction coil with a plurality of ferrite bodies arranged under the induction coil in order to prevent undesired downward propagation of the magnetic field thereof or to route the magnetic field lines downward. Said ferrite bodies can either take the form of long rectangles or of segments of a circle, in particular for instance segments amounting to sixths of a circle. Said ferrite bodies in the form of segments of a circle are advantageously arranged in corner regions of approximately rectangularly configured induction coils.

Alternative configurations of ferrite bodies for induction coils are known from EP 1 991 030 A2. They have shapes which are based substantially on elongate rectangles, being differently configured at one end in the end region.

### OBJECT AND SOLUTION

The object of the present invention is to provide an induction coil as mentioned above, use as mentioned above of ferrite bodies in such an induction coil and an electric cooktop with a plurality of such induction coils, with which the problems of the prior art can be solved and which in particular make it possible to route magnetic fields generated by the induction coil efficiently and well, in particular in the case of use as mentioned above for inductive power transfer, which may take place in accordance with the so-called Ki standard.

This object is achieved by an induction coil having the features of claim 1, by the use of ferrite bodies in an induction coil having the features of claim 22 and by an electric cooktop with a cooktop plate and a plurality of induction coils thereunder having the features of claim 24. Advantageous and preferred embodiments of the invention are contained in the subclaims and are explained in greater detail below. Some of the features are described here only for the induction coil, only for the use or only for the electric cooktop; regardless of this, however, they are intended to apply by themselves and independently of one another not only for such an induction coil and such use but also for such an electric cooktop. The wording of the claims is incorporated into the content of the description by express reference.

The induction coil according to the invention is intended for installation and use in an electric cooktop, in particular under a cooktop plate of the cooktop, advantageously together with further induction coils. The induction coil here has a winding body in the form of a flat, spirally wound coil, as is conventional per se. The winding body is wound from coil wire or so-called stranded coil wire and has an inner connector and an outer connector. These advantageously extend from the winding body as onwardly routed coil wire. Furthermore, the induction coil has at least four individual uniform or identically configured ferrite bodies, which are arranged under the winding body. The ferrite bodies are here advantageously arranged adjacent one another in the circumferential direction of the induction coil. They may cover between 30% and 70% of the area of the winding body.

According to the invention, the ferrite bodies each have two regions, a first region being arranged on the inside and constituting a stem region. This stem region extends substantially in the radial direction. A second region is arranged radially to the outside and is or forms a head region. This head region adjoins the stem region, advantageously in a transition region formed at this point. In terms of angular degrees, the head region is wider at its greatest width than the stem region at its greatest width when viewed in the circumferential direction or is over 50% wider, when viewed in the circumferential direction, than the stem region at its greatest width when viewed in the circumferential direction. In other words, the head region may be over 50% wider or wider in terms of angular degrees at its greatest width than the stem region at the point where it has the smallest width in angular degrees or as an arc angle. Advantageously, however, the head region is in each case no more than 150% wider than the stem region at its greatest width when viewed in the circumferential direction. The ferrite body can thus be regarded as being very approximately of T-like configuration.

Furthermore, the head region projects radially at least in part beyond the winding body or protrudes radially therebeyond. This may amount to between 5% and 30% of the radius of the winding body. The stem region does not extend with a continuous absolute width, but rather widens radially from radially inside to radially outside. This advantageously applies to the absolute width thereof, but not to its width in angular degrees or as an arc angle; in these cases it may vary or its width may even reduce. Such a widthwise direction extends substantially in a circumferential direction of the winding body or approximately at right angles to the radial extent of the ferrite body or the stem region. The stem region narrows radially in terms of angular degrees from radially inside to radially outside over a range of between 40% and 80% of the radius of the winding body and/or over a range of between 25% and 75% of the length of the ferrite body, preferably when viewed radially.

In other words, the lateral sides of the stem region of two directly neighboring ferrite bodies may satisfy the condition that the sum of all distances between ferrite bodies over any desired circle about the center point of the winding body amounts to at least 40%, preferably between 50% and 70%, of the total circumference of this circle. The radius of said any desired circle may amount to between 40% and 90% of the radius of the winding body. Thus, this may apply over a circular ring range of between 70% and 90% of the radius of the winding body. Advantageously, the sum of all the distances may amount to 50% to 70% of the total circumference of said circle.

This specific geometric embodiment ensures that reasonably large distances are provided between neighboring ferrite bodies in the middle, outer region, these ensuring, specifically for the above-stated use for power transfer, that magnetic coupling into an electrically low-resistance support plate under the induction coils in an electric cooktop remains minor. In this way, on the one hand, losses in the support plate remain limited and, on the other hand, the inductance of the above-mentioned receiver coil is not raised too greatly by the openings or free regions of significant size between the ferrite bodies. This would lead to detuning of the resonant frequencies for the inductive power transfer, which would be very disadvantageous therefor.

Furthermore, the widened head regions at the outside of the induction coil and the relatively closely adjacent radially inner ends of the ferrite bodies ensure that the inner winding circumference is magnetically short-circuited with the outer winding circumference over virtually the entire circumference. Magnetic flux increases radially from inside to radially outside, for which reason the absolute width of the ferrite bodies advantageously increases in this direction. In the case of inductive power transfer of high powers, particularly large magnetic fluxes arise, and the specific shape of the ferrite bodies is intended to avoid saturation. It may for instance advantageously be provided that an induction coil with its ferrite bodies, which is also or mainly used for inductive power transfer, is differently configured or has differently configured ferrite bodies and ferrite bodies configured according to the invention. The specific shape thereof and the protrusion of the ferrite bodies beyond the winding body also ensure that, radially inwardly and radially outwardly, no magnetic field components are coupled into a region situated below the induction coil, in particular into a metal support plate.

In one advantageous embodiment of the invention, the ferrite bodies of an or the induction coil are configured identically at least in their head regions, i.e., have uniform head regions. This advantageously also applies to the stated stem region, in particular at the radially inner end thereof. Provision may overall be made for all the ferrite bodies of this induction coil to be of identical configuration, for one induction coil or even for all the identically sized induction coils of a corresponding cooktop, at least if they are also to be provided for inductive power transfer. The use of uniform regions or even identical ferrite bodies simplifies fitting or makes it more cost effective. The ferrite bodies are particularly advantageously of one-piece configuration in their specific shape, i.e., not assembled from different parts. This prevents magnetic fields from leaking out at the joints between individual parts and so causing losses in the winding body and in the support plate. Furthermore, it may simplify mechanical fastening of the ferrite bodies during fitting.

In one embodiment of the invention, provision may be made for the lateral or outer sides of the stem region to extend straight in the radial direction over at least 50% of their length, preferably over a length of 65% to 90%. This makes it easy to ensure that, as defined above, they widen in absolute terms from radially inside to radially outside. As an alternative to extending straight, they may also curve slightly.

The distance in terms of angular degrees between the two lateral sides of the stem region of a ferrite body may reduce from radially inside to radially outside, preferably continuously. The reduction is thus continuous. In particular, the distance may reduce over a range of between 20% or 30% and 80% of the maximum radius of the winding body.

In one embodiment of the invention, the arc angle between the two lateral sides of the stem region of a ferrite body may increase in terms of angular degrees from radially outside to radially inside, wherein it may preferably even increase continuously or monotonically or even strictly monotonically. Thus, while the width in the stem region may decrease in millimeter terms from radially outside to radially inside, in relation to a circle or in the circumferential direction the stem regions of the ferrite bodies may occupy an ever greater proportion amounting advantageously to over 50% in terms of angular degrees.

In a further development of the invention, provision may be made for radially inner end regions of the stem regions to taper even more sharply than do the lateral sides of the stem regions over a substantial proportion of their length, preferably over between 60% and 90% of their length. These radially inner end regions may amount to between 10% and 30% of the length of the ferrite bodies. This still greater taper ensures that the stem regions can extend relatively far toward the center point of the induction coil without touching one another. The width thereof between the two lateral sides of the end regions may increase or remain the same in terms of angular degrees from radially inside to radially outside.

In another further development of the invention, said lateral sides of the tapered end regions of neighboring ferrite bodies may be spaced from one another by at least 5 mm or 5% of the circumference of a circle in this region, advantageously even 8 mm to 12 mm. In this way, an above-mentioned inner connector can be routed through between two neighboring ferrite bodies, on a level therewith. Although this inner connector has to be routed through between two neighboring ferrite bodies at just a single point, said spacing condition may be advantageous for achieving identical ferrite bodies and regular arrangement thereof under the winding body.

In one embodiment of the invention, provision may be made for the tapered end regions of the stem regions not to taper to a point but rather to be cut off at right angles to the radial direction or to the radial longitudinal course of the stem regions. They may be cut off straight, or they may be cut off curved, in particular inwardly curved.

A free region, in which no ferrite bodies or no ferrite material and also no coil turns are provided, may advantageously be provided radially within the tapered end regions of the ferrite bodies. Such a free region may have a diameter of between 2% and 12% of the maximum radius of the winding body. Such a free region is provided above all when said winding body takes the form of a wide circular ring and likewise has a free inner region. It is likewise unnecessary to provide any ferrite material in the form of one or more ferrite bodies in the central inner region of said winding body, so allowing said region to be free.

Provision may be made for the radially innermost turn of the winding body to be arranged over the tapered end regions, such that they project radially inward beyond this innermost coil turn. This allows the magnetic field of the induction coil to be routed both radially inward and radially outward as desired.

In a further configuration of the invention, with regard to the above-stated end regions the ratio of the smallest distance between neighboring ferrite bodies at the end regions to the smallest distance between neighboring ferrite bodies at the head regions may be between 0.7 and 1.5, preferably between 0.9 and 1.2, in terms of absolute width. Provision may be made for the distance to be at its smallest at the point where the ferrite bodies are at their narrowest, in particular at the inner ends. The inner connector may not even necessarily have to be routed through here, for which reason the distance between them may be at its smallest specifically at this point. Alternatively or in addition, the ratio of the smallest distance between neighboring ferrite bodies at the end regions to the smallest distance between neighboring ferrite bodies at the head regions is between 1.5 and 5, preferably between 2.5 and 3.5, in terms of angular degrees.

In one alternative embodiment of the invention, the distance between neighboring ferrite bodies at the head region may be just as small, in absolute number terms, as the smallest distance at the end regions.

The distance in terms of angular degrees between two neighboring ferrite bodies at the head regions may amount to between 2 and 8 angular degrees. The minimum distance between two neighboring ferrite bodies at the end regions may amount to between 10 and 20 angular degrees.

In a further configuration of the invention, the proportion occupied by the distance between neighboring ferrite bodies in the circumferential direction or as an arc angle in terms of angular degrees of the total circumference at any point of the radial extent may amount to over 40%, no greater distance being provided between neighboring ferrite bodies as it were at any point. Provision may advantageously even be made for this proportion to amount to over 50% over more than half the radial extent, i.e., over a significant region more than 50% of a circle does not extend over a ferrite body. This is true in particular of the above-stated radius range of between 40% and 90% of the radius of the winding body.

In one further development of the invention, a transition region may be provided between the head region and the stem region. This may be of rounded configuration, so simplifying the mechanical stability and manufacture of the ferrite bodies. The radius of the rounded transition region may be between 5% and 20% of the radius of the winding body. The distance in terms of absolute width between two neighboring ferrite bodies may preferably be at its greatest in this transition region, wherein in particular the transition region lies at or covers between 70% and 105% of the radius of the winding body.

Furthermore, in the above-stated transition region provision may be made for the distance between neighboring ferrite bodies to be at its greatest here, advantageously amounting to between 70% and 90% of the radius of the winding body. This makes it possible for the head region to extend relatively quickly a long way to each side or become very wide radially immediately to the outside of the transition region, so ensuring that the head regions exhibit their greatest width radially somewhat to the outside of the winding body and that they virtually abut one another at their ends.

A significant proportion of the area of the head region may be arranged radially outside the winding body and thus protrude radially therebeyond. This proportion may be at least 50%, and preferably between 65% and 95%. In particular, the head region may widen significantly radially to the outside of the outermost turn of the winding body. The transition region here advantageously lies exactly under this outermost turn.

Overall, provision may be made for the ferrite bodies to cover between 40% and 70% of the area of the winding body. The proportion may particularly advantageously be between 45% and 60%, for example thus around half.

Although the stem region is radially significantly longer than the head region, the latter region may nonetheless have a radial extent of between 10% and 35% of the radial length of the stem region. Its width may be several times greater than its radial extent, so achieving the above-mentioned T-like shape.

For example, an absolute width of the head region in the circumferential direction may be 30% to 100% greater than the absolute width of the stem region prior to the transition to the head region or prior to the above-stated transition region. The stated T-like shape of the ferrite body may also be achieved thereby.

In a further embodiment of the invention, the distance between two neighboring ferrite bodies may amount to between 2 and 8 angular degrees at the head regions thereof. The minimum distance between two neighboring ferrite bodies at the end regions may amount to between 10 and 20 angular degrees. The distance in terms of angular degrees at the end regions of the stem regions may thus be greater than at the head regions. The reason for this may primarily be that explained above, i.e., the need to route the inner connector through between two neighboring ferrite bodies at the end regions. This enables the structural height of the induction coil to remain small, since the inner connector does not have to be routed below a ferrite body, which would otherwise result in their thicknesses being added together.

One embodiment of the ferrite bodies is advantageously mirror-symmetrical, such that, on fitting, they may for example also be correctly fitted with their underside facing upward. This mirror symmetry is advantageously related to an axis which extends exactly in the radial direction of the induction coil and of the winding body.

One arrangement of the ferrite bodies is preferably axially symmetrical, in particular also point-symmetrical. It is particularly preferably axially symmetrical relative to two axes of symmetry extending at right angles to one another, wherein these axes of symmetry may extend between two ferrite bodies or through two ferrite bodies. Particularly advantageously, one axis of symmetry here passes exactly centrally through two opposing ferrite bodies and the other either does the same or extends exactly half-way between two adjoining ferrite bodies. Additionally or alternatively, the arrangement of the ferrite bodies on an induction coil may be point-symmetrical, preferably relative to a center point of the induction coil and of the winding body.

In a further development of the invention, provision may be made for the head region to be formed by two head end portions or for it to have such head end portions. These are preferably configured transversely of or at right angles to the longitudinal direction of the stem region. They may be configured to taper toward their free ends, in particular they may be rounded at their free ends. Particularly advantageously, the smallest distance in terms of both absolute width and angular degrees between neighboring ferrite bodies is at these protruding head end portions. In this way, a largely or almost continuous circumferential ring of ferrite material may be created which, for the above-stated reasons due to the specific mode of operation for high-power wireless energy transfer, runs around the winding body.

Advantageously, provision is made for the outer edge of the winding body or its outermost turn to run exactly over the transition region between stem region and head region. This ensures that the radially inward-lying region of the ferrite body, namely the stem region, covered by the winding body specifically does not protrude significantly radially to the outside of the latter. The head region here provided outside the winding body may be significantly wider outside the winding body. Provision may be made for the outermost turn of the winding body to extend exactly between the stem region and the head region, thus as it were centrally between these two over the transition region.

The ferrite bodies or each ferrite body preferably have/has a per se constant thickness which is in each case mutually uniform. This may advantageously be between 3 mm and 7 mm, particularly advantageously around 5 mm. This is easily sufficient to route the magnetic field lines as described above. At the same time, the structural height of the finished induction coil is consequently not excessive.

As a further geometric detail, provision may be made for the length of the ferrite bodies in the radial direction to amount to 5 cm to 15 cm. Advantageously, over 75% thereof is taken up by the length of the stem regions.

The ferrite bodies are preferably of one-piece configuration, making them easier to fit and enabling them to better direct the magnetic flux. They may be made from pressed ferrite material, which may then be ground into a defined shape. Although the outer contour of the ferrite bodies is preferably relatively complex, within this outer contour a ferrite body does not, however, have to have any holes or openings or recesses.

An above-mentioned inner connector of the winding body may be routed on from the innermost coil turn with coil wire or stranded coil wire and run between two radially inner ends or above-described end regions of neighboring ferrite bodies. It may thus extend in the same plane as the ferrite bodies and not thereunder, so enabling the structural height to be reduced. Here, the inner connector may then extend from the innermost turn radially outward between two ferrite bodies and emerge under the winding body for example at the same point at which the outer connector also emerges. They may thus, as it were, form a common connector strand, so simplifying fitting and connection of the induction coil in the cooktop.

As was explained above, ferrite bodies of an above-described shape, in particular the T-like shape, are not only generally used in a cooktop or an induction cooktop in a structural unit with induction coil but also primarily for inductive power transfer to a stated electrical consumer, for example a kitchen appliance such as a mixer, toaster or the like which has a receiver coil. This results in inductive power transfer, as known from the prior art, which provides the electrical consumer with current or electrical energy for operation thereof. Such inductive power transfer may advantageously take place in accordance with the Ki standard, see for example U.S. Pat. No. 11,699,924 B. A receiver coil as mentioned above should be of similar size to the induction coil, but may also be of a different size.

It is precisely for such inductive power transfer that the shape according to the invention of the ferrite bodies is significant, said shape encompassing a virtually continuous ring of ferrite material in the outer region of the winding body which is substantially formed by the above-described widened head regions. In the middle region of the winding body, less ferrite material is provided or neighboring ferrite bodies are at a significant distance from one another, since here the magnetic resistance would otherwise become too high. In the radially inner region of the winding body ferrite material is again provided in a circle, likewise with minor interruptions, but this may be achieved without widening of the ferrite bodies since, with the correspondingly small radii in this region, they lie relatively close together anyway or exhibit relatively small distances from one another.

An electric cooktop according to the invention has a cooktop plate and a plurality of induction coils, wherein there may advantageously also be multiple such induction coils. The cooktop plate may advantageously be formed of conventional material such as for example vitreous ceramic with a thickness of a few millimeters, advantageously 3 mm to 5 mm, in particular 4 mm. The distance between the top of the winding body and the top of the cooktop plate should not be too great, either for inductive cooking on the one hand or for the above-stated inductive power transfer to an electrical consumer with receiver coil placed on the cooktop plate on the other hand. The distance between the top of the winding body and the top of the cooktop plate may thus be between 5 mm and 13 mm, and particularly advantageously amount to around 8 mm.

A flat support plate is preferably provided under the cooktop plate, on which support plate an above-mentioned induction coil according to the invention is placed, particularly advantageously all the induction coils of this cooktop. The flat support plate may be made of metal, in particular aluminum. It should be of low electrical resistance and may, for example, consist of an aluminum alloy or exhibit an electrical conductivity of greater than 20 MS/m.

These and further features are revealed in the description and in the drawings as well as in the claims, wherein the individual features can be realized singly or severally in the form of subcombinations in one embodiment of the invention and in other fields, and can constitute advantageous embodiments eligible for protection in themselves, for which protection is here sought. The subdivision of the application into individual sections and sub-headings does not limit the statements made thereunder in their general validity.

### BRIEF DESCRIPTION OF THE DRAWINGS

Further advantages and aspects of the invention can be found in the claims and in the description of exemplary embodiments of the invention that are explained in the following with reference to the figures, in which:

FIG. 1 is a sectional representation through a cooktop according to the invention, with three conventional induction heating coils and an induction coil according to the invention,

FIG. 2 is a plan view of the cooktop of FIG. 1 with the induction coil according to the invention front right,

FIG. 3 is a plan view of an induction heating coil according to the invention with round winding body and six ferrite bodies of T-like configuration,

FIG. 4 is an oblique representation of the induction coil of FIG. 3 on a support plate of the cooktop,

FIG. 5 is a plan view of one of the ferrite bodies of FIG. 3,

FIG. 6 is an oblique view from the front of the ferrite bodies of FIG. 5 and

FIG. 7 shows an enlarged portion of the induction coil of FIG. 3, including lines corresponding to different angular degrees and a percent scale relating to the radius of the winding body.

### DETAILED DESCRIPTION OF THE EXEMPLARY EMBODIMENTS

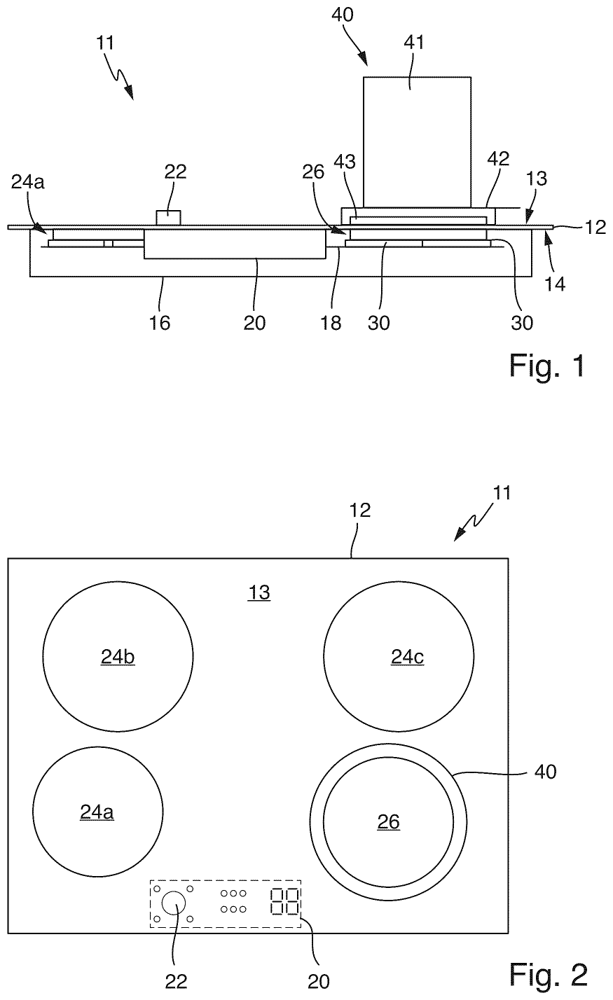

FIG. 1 is a lateral sectional representation of a cooktop 11 according to the invention which is largely of known construction. The cooktop 11 has a conventional cooktop plate 12 with a top 13 and a bottom 14. A housing 16, in which the various functional units of the cooktop 11 are arranged, is arranged on the bottom 14. A support plate 18 of aluminum, advantageously with an above-mentioned high conductivity of 20 MS/m or even higher, extends in the housing 16, parallel to the cooktop plate 12. In front thereof, an operating means 20 is arranged, in its own housing, said operating means 20 having, inter alia, a rotary knob 22, positionable on the top 13, for operating the cooktop 11.

Three induction coils 24a to 24c are placed on the support plate 18 and rest against the bottom 14. Instead of a conventional fourth induction heating coil, an induction coil 26 according to the invention is arranged, specifically front right according to FIG. 2. The induction heating coils 24a to 24c serve merely for inductive heating of a cooking vessel placed thereon. The induction coil 26 according to the invention may, on the one hand, of course also be used for inductive heating of a cooking vessel. On the other hand, however, it may also be used to operate a consumer placed thereover onto the cooktop plate 12, in accordance with the above-mentioned Ki standard. The cooktop 11 could, however, also have more or even only such induction coils according to the invention.

The consumer is here a mixer 40, which has a mixer container 41. This mixer container contains within it a stirrer or the like, not shown here. The mixer container 41 sits on a mixer base 42, with which the mixer 40 is set down onto the top 13 of the cooktop plate 12. A receiver coil 43 is provided in the mixer base 42 advantageously as far down as possible or as close to the cooktop plate 12 as possible and thus also to the induction coil 26 arranged therebelow. This may be somewhat smaller than the induction coil 26 according to the invention, but the sizes may also differ more greatly. As a result of the inductive energy transfer from the induction coil 26 to the receiver coil 43, the mixer 40 is supplied wirelessly with electrical energy for operation thereof.

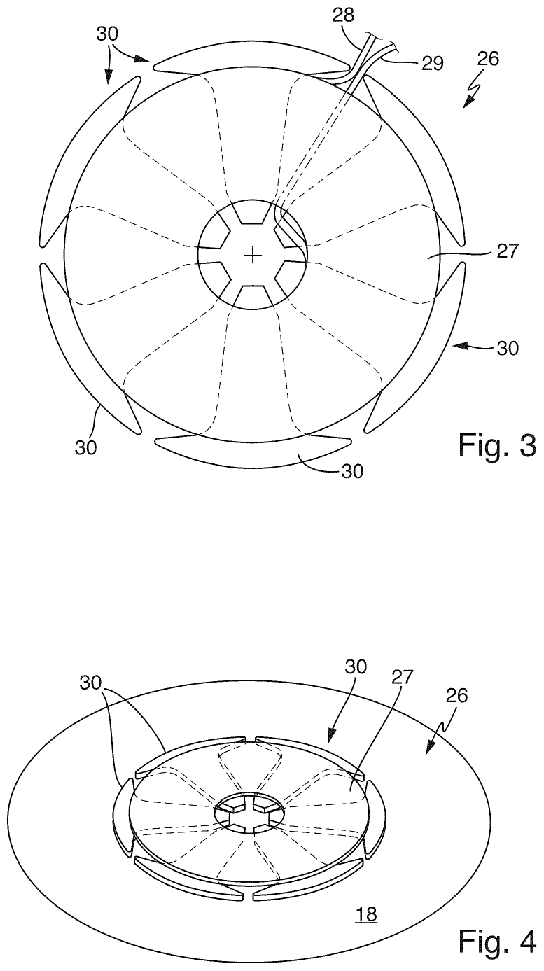

FIG. 3 is a plan view showing the induction coil 26 according to the invention. It has a per se conventional winding body 27, which is wound flat, in a spiral and in a single layer from so-called coil wire, wherein the coil wire has a plurality of individual stranded wires which are advantageous twisted together. On the outside, an outer connector 28 extends uninterruptedly from the winding body 27 and advantageously a few centimeters further in the plane of the winding body 27, in particular all the way to electrical terminals in the housing 16. Likewise, on the inside, an inner connector 29 extends uninterruptedly from the innermost turn of the winding body 27 and is routed radially outward and then routed together with the outer connector 28.

Under the winding body 27 six identical ferrite bodies 30 are arranged, which are shown by dashed lines in this region. They are arranged evenly distributed, wherein the ferrite bodies 30 project a little from under the winding body on the inside and outside. FIG. 4 shows the induction coil 26 in an oblique representation, wherein it has here been placed onto the support plate 18 with the ferrite bodies 30 facing downward.

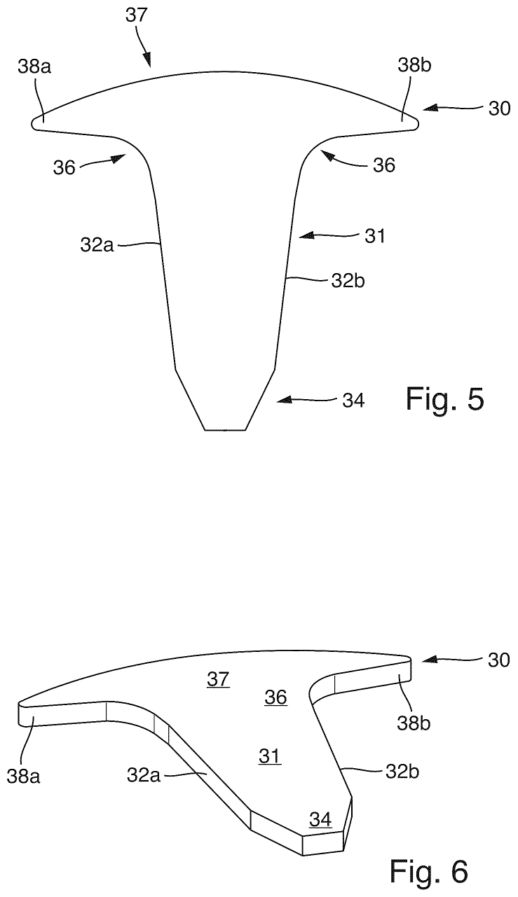

The specific shape of the ferrite bodies 30 will be explained in greater detail with reference to FIGS. 5 and 6 and the detailed designations provided therein. Fundamentally, they have an elongate stem region 31, which has a left lateral side 32a and a right lateral side 32b. At the lower end, which according to FIG. 3 lies in a central free region of the winding body 27, the stem region 31 merges into the tapering end region 34. At the very bottom end, this end region 34 is cut off at right angles to the longitudinal direction of the stem region 31, wherein this could also be of more or less rounded configuration; the corners could likewise be rounded.

The stem region 31 widens in a radially outward direction, relative to the induction coil 26 or the winding body 27 thereof according to FIG. 3, specifically by about 35%. Advantageously, it has straight lateral sides 32a and 32b and therefore widens uniformly. The widened stem region 31 is adjoined, via a transition region 36, by a head region 37. In the transition region 36 the ferrite body 30 widens starting from the lateral sides 32a and 32b and with wide rounding. The ferrite body 30 then merges into the head region 37, where it widens greatly. There it forms the outward-pointing head end portions 38a on the left and 38b on the right. The outward-pointing outer edge of the head region 37 is widely rounded and extends in particular roughly parallel to the outer edge of the winding body 27, see FIG. 3, such that all the outer edges of the ferrite bodies 30 lie on a single circle.

The lateral sides 32a and 32b are here of largely straight configuration from the tapered end region 34 to shortly before the transition region 36 or virtually up thereto. The transition to the tapered end region 34 is provided with a corner, but could also be rounded. The lateral sides of the tapered end region 34 could also be slightly curved or arched. At the inward-pointing end face, slight rounding could also be provided instead of the corners shown.

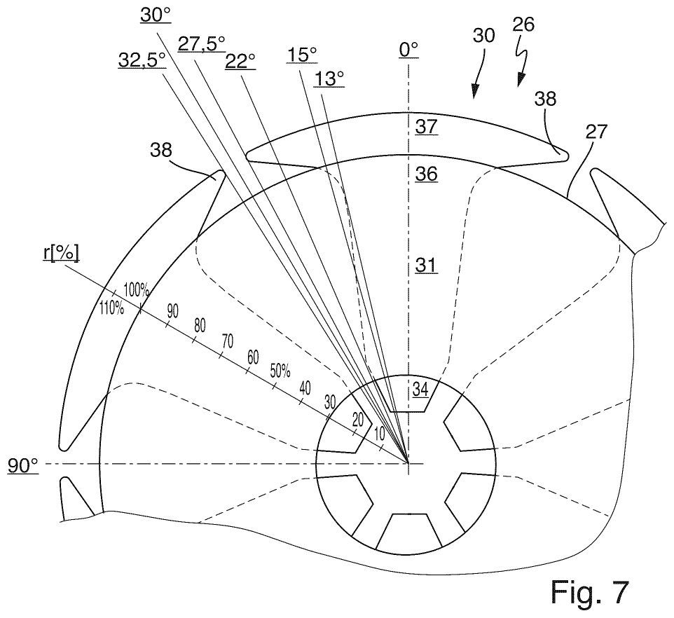

The specific shape of the six ferrite bodies 30 according to FIG. 3 is therefore due to the fact that, on the one hand, an identical embodiment offers advantages for manufacture and fitting thereof and is thus more cost-effective. Furthermore, the shape of the ferrite bodies 30 serves to ensure that as much ferrite material as possible is provided at the radially inner and outer extremes or in the region of the innermost and outermost turns of the winding body 27 as viewed in circumferential direction or that said material is, as far as possible, present in a virtually continuous circle. Radially to the inside, the ferrite bodies 30 must have a certain distance between one another, which may in practice amount to the above-mentioned 8 mm. In this way, the inner connector 29 may be routed through in the plane of the winding body 27 without the structural height of the induction coil 26 having to be increased. This would namely otherwise be the case if the ferrite bodies 30 were to touch in the inner free region or under the innermost turn of the winding body 27 or were to extend so close to one another that the inner connector 29 had to be routed through under the ferrite bodies 30. At the same time, it is however also clear from FIG. 3 that, due to the relatively small distance between the tapered end regions 34 of the ferrite bodies 30 a lot of ferrite material is provided in this region, so to speak. This means that the entire magnetic flux can be routed in the ferrite material, such that ultimately no magnetic field components can couple with the support plate 18 therebelow. The ferrite bodies 30 also need to be of sufficient volume in these end regions 34 especially in a situation where a relatively large magnetic flux may occur in the induction coil 26 and in the receiver coil 43 without saturation in the event of a poor phase angle between the currents. Accordingly, in this region the width of the ferrite bodies 30 also increases in terms of angular degrees or, as illustrated here, in any event does not reduce appreciably. This is also clear from FIG. 7.

Correspondingly, the ferrite bodies 30 are also configured to be of such a width in the region of the outermost turn of the winding body 27, or indeed radially to the outside thereof, that the protruding head end portions 38a and 38b thereof almost touch in comparison with the major circumference. It is thus possible in this region too to route the entire magnetic flux in the ferrite bodies 30 or simply in the head regions 37, i.e. again in the ferrite material.

In the substantial region of the area of the winding body, in particular in an outer region, the ferrite bodies 30 are relatively narrow in their stem regions 31 or become even narrower from radially inside to radially outside toward the head regions 37. This is illustrated by the depiction in terms of angular degrees according to FIG. 7 in the range between 60% or 70% and 90%. This results in large, approximately triangular free areas between neighboring ferrite bodies 30 in which no ferrite material is arranged under the winding body 27. This reduces overall excessive magnetic coupling into the receiver coil 43 and the effect of the ferrite bodies 30 on the self-inductance of the receiver coil 43, which is also known as a cross-effect between the induction coil 26 and the receiver coil 43. Coupling is here relatively significant due to the relatively small distance of in practice between 8 mm and 13 mm between induction coil 26 and receiver coil 43, as shown in FIG. 1. In the event of such inductive power transfer, high powers are transferred in the event of major coupling at working frequencies significantly below the resonant frequency of the receiver coil 43, wherein phase angles that are relatively small in magnitude are present between the currents in the induction coil 26 on the one hand and in the receiver coil 43 on the other hand. Increased inductance of the receiver coil 43 reduces the resonant frequency thereof. In combination with the above-stated strong coupling, the working frequency for inductive power transfer may fall below the permitted minimum working frequency of 20 kHz, if at the same time a nominal power of for example 2200 W is to be achieved in the consumer. Moreover, the phase angle of the current through the receiver coil relative to the current through the induction coil 26 would otherwise also deteriorate. This would require even greater current through the induction coil 26 for induction of the same power in the receiver coil 43 or the mixer 40 or the consumer, resulting in increased losses. This may be reduced by the relatively large free areas between pairs of neighboring ferrite bodies 30.

In comparison with a simple T shape of the ferrite bodies 30, which would then, as it were, consist of two assembled elongate rectangles, the shape according to the invention exhibits good coupling due to the ferrite material of the ferrite bodies 30 adjoining relatively closely in the circumferential direction at the inner and outer extremes. Furthermore, the ferrite material at the inner circumference of the innermost turn of the winding body 27 may be connected with low magnetic resistance with the outer circumference or the outermost turn of the winding body 27. Due to the large free areas between neighboring ferrite bodies 30, the above-stated cross-effect to the receiver coil 43 can remain insignificant. The magnetic flux density here has its maximum at the transition from stem region 31 to head region 37, i.e., in the transition region 36.

For an explanation of the precise shape of the ferrite bodies 30 in terms of angular degrees, reference is made to FIG. 7. An axis of symmetry of the axially symmetrical ferrite body 30 lies at 0 angular degrees. The smallest width in terms of angular degrees lies at or shortly before the transition region 37, namely at the 13 angular degrees line. In comparison, it can be seen that the 15 angular degrees line is intersected by the left lateral side 32a, specifically roughly in the middle region thereof. This results specifically in the stem region 31 becoming narrower, in terms of angular degrees, from radially inside to radially outside, while in terms of absolute width, i.e., measured in millimeters, it is of course becoming wider. The transition region 36 lies at the 15 angular degrees line, or alternatively this line also marks half of a segment amounting to a twelfth of the circle. Somewhat to the outside of this line, the outer circumference of the winding body 27 intersects the edge of the ferrite body 30.

The sides of the end region 34 extend in a virtually radial direction, here specifically at around 22 angular degrees. The end region 34 thus, like the stem region 31, narrows slightly from radially inside to radially outside.

The outermost ends of the head end portions 38a lie at around 27.5 angular degrees, such that the distance thereof from the 30 angular degrees line, which extends exactly halfway between two neighboring ferrite bodies 30, amounts to just 2.5 angular degrees. In practice, the distance between neighboring head end portions may amount to 8 mm to 15 mm, i.e., may be similar to the distance at the tapered end regions 34.

As has been explained above, the width of the stem region 31 or the distance between the two lateral sides 32a and 32b decreases radially in the range between just under 40% and around 80%. Radially to the inside of this, the sides of the ferrite body 30 extend in the tapered end regions 34 in such a way that the distance between them in terms of angular degrees remains virtually unchanged.

FIG. 7 also shows that the radial extent of the head regions 30 is relatively small and amounts to only about 15% of the maximum radius of the winding body 27.

1. An induction coil for an electric cooking appliance, wherein said induction coil has:
a winding body in a form of a flat, spirally wound coil being wound from coil wire and having an inner connector and an outer connector, and
at least four individual, identical ferrite bodies under said winding body,
wherein:
said ferrite bodies each have two regions, wherein
a first, inner region is a stem region,
said stem region extends substantially radially,
a second, outer region is a head region, and
said head region adjoins said stem region, and is wider in terms of angular degrees at its greatest width than said stem region at its greatest width and in terms of absolute width is over 50% wider than said stem region at its greatest width,
said head region projects radially at least in part beyond said winding body or protrudes therebeyond,
said stem region widens radially in terms of absolute width from radially inside to radially outside, and
said stem region narrows radially in terms of angular degrees from radially inside to radially outside over a range of between 40% and 80% of a radius of said winding body and/or over a range of between 25% and 75% of a length of said ferrite body.

2. The induction coil as claimed in claim 1, wherein said ferrite bodies are of identical configuration at least in said head region or overall all said ferrite bodies of said induction coil are identically configured.

3. The induction coil as claimed in claim 1, wherein a distance in terms of angular degrees between two lateral said sides of said stem region of a ferrite body reduces from radially inside to radially outside over a range of from 20% to 80% of a maximum radius of said winding body.

4. The induction coil as claimed in claim 1, wherein said stem regions have radially inner end regions, wherein said radially inner end regions taper even more sharply than do lateral sides of said stem region over a substantial proportion of its length, and wherein a width in terms of angular degrees between said two lateral sides of said end regions increases from radially inside to radially outside or remains unchanged.

5. The induction coil as claimed in claim 4, wherein said lateral sides of said tapered end regions of neighboring ferrite bodies are spaced from one another by at least 5 mm or 5% of a circumference of a circle in said region.

6. The induction coil as claimed in claim 4, wherein a free region is provided radially within said tapered end regions being free of ferrite bodies and turns, wherein a diameter of said free region amounts to 2% to 20% of a maximum radius of said winding body.

7. The induction coil as claimed in claim 4, wherein an innermost turn of said winding body is arranged radially over approximately half a length thereof over said tapered end regions.

8. The induction coil as claimed in claim 4, wherein a ratio of a smallest distance between neighboring said ferrite bodies at said end regions to a smallest distance between neighboring said ferrite bodies at said head regions is between 0.7 and 1.5 in terms of absolute width and/or a ratio of a smallest distance between neighboring said ferrite bodies at said end regions to a smallest distance between neighboring said ferrite bodies at said head regions is between 1.5 and 5 in terms of angular degrees.

9. The induction coil as claimed in claim 1, wherein a distance between two neighboring said ferrite bodies at said head regions amounts to between 2 and 8 angular degrees and/or a minimum distance between two neighboring said ferrite bodies at said end regions amounts to between 10 and 20 angular degrees.

10. The induction coil as claimed in claim 1, wherein said head region adjoins said stem region in a transition region and said transition region is of rounded configuration, wherein a distance in terms of absolute width between two neighboring said ferrite bodies is at its greatest in said transition region.

11. The induction coil as claimed in claim 10, wherein said transition region lies at or covers between 70% and 105% of a radius of said winding body.

12. The induction coil as claimed in claim 1, wherein between 65% and 95% of an area of said head region is arranged radially outside said winding body and protrudes radially therebeyond.

13. The induction coil as claimed in claim 1, wherein said ferrite bodies cover between 40% and 70% of an area of said winding body.

14. The induction coil as claimed in claim 1, wherein said head region has a radial extent of between 10% and 35% of a radial extent of said stem region.

15. The induction coil as claimed in claim 1, wherein an absolute width of said head region in the circumferential direction amounts to 30% to 100% more than an absolute width of said stem region prior to a transition to said head region.

16. The induction coil as claimed in claim 1, wherein said ferrite bodies are of mirror-symmetrical configuration.

17. The induction coil as claimed in claim 1, wherein said ferrite bodies are arranged axially symmetrically relative to two axes of symmetry extending at right angles to one another.

18. The induction coil as claimed in claim 1, wherein said head region has two head end portions of tapered configuration protruding transversely of or at right angles to a longitudinal direction of said stem region, wherein a smallest distance in terms of both absolute width and angular degrees between two neighboring said ferrite bodies is at said protruding head end portions.

19. The induction coil as claimed in claim 1, wherein an outer edge of said winding body or an outermost turn of said winding body extends over a transition region between said stem region and said head region of said ferrite bodies.

20. The induction coil as claimed in claim 1, wherein said ferrite bodies are of one-piece configuration and are made from compressed ferrite material.

21. The induction coil as claimed in claim 1, wherein said stem regions have radially inner end regions, wherein an inner connector extends from an innermost turn radially outward between two radially inner ends or end regions of said ferrite body or of said stem region.

22. Use of ferrite bodies in an induction coil for inductive power transfer from said induction coil to an electrical consumer having a receiver coil and positioned spaced from said induction coil, wherein said ferrite bodies exhibit a structure as follows:
said ferrite bodies each have two regions, wherein
a first, inner region is a stem region,
said stem region extends substantially radially,
a second, outer region is a head region, and
said head region adjoins said stem region, and is wider in terms of angular degrees at its greatest width than the stem region at its greatest width and in terms of absolute width is over 50% wider than said stem region at its greatest width,
said head region projects radially at least in part beyond said winding body or protrudes therebeyond,
said stem region widens radially in terms of absolute width from radially inside to radially outside, and
said stem region narrows radially in terms of angular degrees from radially inside to radially outside over a range of between 40% and 80% of a radius of said winding body and/or over a range of between 25% and 75% of a length of said ferrite body.

23. Use as claimed in claim 22, wherein said inductive power transfer takes place in accordance with a Ki standard.

24. An electric cooktop with a cooktop plate, and a plurality of induction coils as claimed in claim 1 under said cooktop plate, wherein a distance between a top of said winding body and a top of said cooktop plate amounts to between 5 mm and 13 mm.

25. The electric cooktop as claimed in claim 24, wherein a flat support plate is provided under said cooktop plate, on which support plate all said induction coils of said cooktop are placed, wherein said ferrite bodies are arranged below said winding body and above said support plate.
